(19) United States
(12) Patent Application Publication
(10) Pub. No.: US 2010/0145676 A1
(43) Pub. Date: Jun. 10, 2010

(54) METHOD AND APPARATUS FOR ADJUSTING THE LENGTH OF TEXT STRINGS TO FIT DISPLAY SIZES

(75) Inventor: Sean S. ROGERS, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/330,730

(22) Filed: Dec. 9, 2008

(51) Int. Cl. G06F 17/27

(52) U.S. Cl. 704/9

(57) ABSTRACT

The various aspects provide methods and devices which can reduce the length of a text string to fit dimensions of a display by identifying and deleting elements of the string that are not essential to its meaning. In the various aspects, handheld devices may be configured with software configured to analyze and modify text strings to shorten their length by adjusting font size, changing fonts, deleting unnecessary words, such as articles, abbreviating some words, deleting letters (e.g., vowels) from some words, and deleting non-critical words. The order in which transformations are affected may vary depending upon the text string according to a priority of transformations. Such transformation operations may be applied incrementally until the text string fits within the display size requirements. Similar methods may be implemented to increase the length of text strings by adding words in a manner that does not substantially change the meaning of the text string.

### FIELD

The present invention relates to cellular telephone handset devices, and more particularly to a mobile handset devices configured to change the length of text strings to fit a display.

### BRIEF DESCRIPTION OF RELATED ART

Mobile handsets, such as cellular phones and PDAs, are becoming ever more useful information tools for users. Mobile handsets are also constantly decreasing in size. These two trends are in tension with each other as smaller display screens make it difficult to view large amounts of information at one time. Even simple message service (SMS) text strings may not fit on a display, requiring users to scroll to read such short messages.

### SUMMARY

In one aspect, a method for transforming a text string for display in a mobile device includes determining a maximum size for displayed strings, determining a length of the text string and transforming the text string so that the transformed text string fits within the maximum size for displayed strings. The method for transforming the text string may be accomplished using an automated string transformation method selected from the group consisting of deleting unnecessary words from the text string, replacing some words in the text string with abbreviations, deleting one or more letters from selected words in the text string, and identifying and deleting non-critical words from the text string. The method may further include transforming the text string further changing a font size or a font spacing. The automated string transformation method of deleting unnecessary words from the text string, may include selecting a word from the text string, comparing the selected word to a list of unnecessary words, and transforming the text string by deleting the selected word if the selected word substantially matches an entry in the list of unnecessary words. The automated string transformation method of replacing some words in the text string with abbreviations may include selecting a word from the text string, comparing the selected word to an abbreviation dictionary, and transforming the text string by replacing the selected word with an abbreviation of the selected word identified in the dictionary if the selected word substantially matches an entry in the abbreviation dictionary. The automated string transformation method of deleting one or more letters from selected words in the text string may include selecting a word from the text string, comparing the selected word to a list of word transformation rules, and transforming the text string by transforming the selected word if the selected word substantially matches a criteria in the list of word transformation rules. The automated string transformation method of identifying and deleting non-critical words from the text string may include diagramming the text string to identify a grammatical type and sentence element of each word in the text string, assigning priority values to the words in the text string according to their identified grammatical type and sentence element, and transforming the text string by deleting a word from the text string having a highest assigned priority. These methods may be repeated until all words in the text string have been selected or all words in the text string have been selected. The method may include determining a priority value for each of the automated string transformation methods within the groups of automated string transformation methods, and implementing automated string transformation methods in order of the determined priority value until the transformed text string fits within the maximum size for displayed strings.

In another aspect, a mobile device is provided including a display and a processor that is configured to perform operations for transforming a text string for display in a mobile device that includes determining a maximum size for displayed strings, determining a length of the text string and transforming the text string so that the transformed text string fits within the maximum size for displayed strings. The operations for transforming the text string may be accomplished by the processor using an automated string transformation process selected from the group consisting of deleting unnecessary words from the text string, replacing some words in the text string with abbreviations, deleting one or more letters from selected words in the text string, and identifying and deleting non-critical words from the text string. The processor may further transform the text string by changing a font size or a font spacing. The processor performed automated string transformation process of deleting unnecessary words from the text string, may include selecting a word from the text string, comparing the selected word to a list of unnecessary words, and transforming the text string by deleting the selected word if the selected word substantially matches an entry in the list of unnecessary words. The processor performed automated string transformation process of replacing some words in the text string with their abbreviations may include selecting a word from the text string, comparing the selected word to an abbreviation dictionary, and transforming the text string by replacing the selected word with an abbreviation of the selected word identified in the dictionary if the selected word substantially matches an entry in the abbreviation dictionary. The processor performed automated string transformation process of deleting one or more letters from selected words in the text string may include selecting a word from the text string, comparing the selected word to a list of word transformation rules, and transforming the text string by transforming the selected word if the selected word substantially matches a criteria in the list of word transformation rules. The processor performed automated string transformation process of identifying and deleting non-critical words from the text string may include diagramming the text string to identify a grammatical type and sentence element of each word in the text string, assigning priority values to the words in the text string according to their identified grammatical type and sentence element, and transforming the text string by deleting a word from the text string having a highest assigned priority. Processor may be repeat the transformation processes until all words in the text string have been selected or all words in the text string have been selected. The processor may further determine a priority value for each of the automated string transformation methods within the groups of automated string transformation methods, and implement the automated string transformation methods in order of the determined priority value until the transformed text string fits within the maximum size for displayed strings.

In another aspect, a mobile device may include a means for transforming a text string for display in a mobile device including a means for determining a maximum size for displayed strings, a means for determining a length of the text string and a means for transforming the text string so that the transformed text string fits within the maximum size for displayed strings. The means for transforming the text string may be accomplished using an automated string transformation means selected from the group consisting of a means for deleting unnecessary words from the text string, a means for replacing some words in the text string with abbreviations, a means for deleting one or more letters from selected words in the text string, and a means for identifying and deleting non-critical words from the text string. The mobile device may further include a means for changing a font size or a font spacing. The automated string transformation means for deleting unnecessary words from the text string, may include a means for selecting a word from the text string, a means for comparing the selected word to a list of unnecessary words, and a means for transforming the text string by deleting the selected word if the selected word substantially matches an entry in the list of unnecessary words. The automated string transformation means for replacing some words in the text string with abbreviations may include a means for selecting a word from the text string, a means for comparing the selected word to an abbreviation dictionary, and a means for transforming the text string by replacing the selected word with an abbreviation of the selected word identified in the dictionary if the selected word substantially matches an entry in the abbreviation dictionary. The automated string transformation means for deleting one or more letters from selected words in the text string may include a means for selecting a word from the text string, a means for comparing the selected word to a list of word transformation rules, and a means for transforming the text string by transforming the selected word if the selected word substantially matches a criteria in the list of word transformation rules. The automated string transformation means for identifying and deleting non-critical words from the text string may include a means for diagramming the text string to identify a grammatical type and sentence element of each word in the text string, a means for assigning priority values to the words in the text string according to their identified grammatical type and sentence element, and a means for transforming the text string by deleting a word from the text string having a highest assigned priority. The mobile device may also include a means for repeating the operations until all words in the text string have been selected or all words in the text string have been selected. The mobile device may include a means for determining a priority value for each of the automated string transformation methods within the groups of automated string transformation methods, and a means for implementing automated string transformation methods in order of the determined priority value until the transformed text string fits within the maximum size for displayed strings.

In another aspect, a computer program product is providing that includes a computer-readable medium including instructions for transforming a text string for display in a mobile device includes at least one instruction for determining a maximum size for displayed strings, at least one instruction for determining a length of the text string and at least one instruction for transforming the text string so that the transformed text string fits within the maximum size for displayed strings. The instructions for transforming the text string may include at least one instruction for deleting unnecessary words from the text string, at least one instruction for replacing some words in the text string with abbreviations, at least one instruction for deleting one or more letters from selected words in the text string, and at least one instruction for identifying and deleting non-critical words from the text string. The instructions may further include at least one instruction for transforming the text string further changing a font size or a font spacing. The automated string transformation instructions for deleting unnecessary words from the text string, may include at least one instruction for selecting a word from the text string, at least one instruction for comparing the selected word to a list of unnecessary words, and at least one instruction for transforming the text string by deleting the selected word if the selected word substantially matches an entry in the list of unnecessary words. The automated string transformation instructions for replacing some words in the text string with abbreviations may include at least one instruction for selecting a word from the text string, at least one instruction for comparing the selected word to an abbreviation dictionary, and at least one instruction for transforming the text string by replacing the selected word with an abbreviation of the selected word identified in the dictionary if the selected word substantially matches an entry in the abbreviation dictionary. The automated string transformation instructions for deleting one or more letters from selected words in the text string may include at least one instruction for selecting a word from the text string, at least one instruction for comparing the selected word to a list of word transformation rules, and at least one instruction for transforming the text string by transforming the selected word if the selected word substantially matches a criteria in the list of word transformation rules. The automated string transformation instructions for identifying and deleting non-critical words from the text string may include at least one instruction for diagramming the text string to identify a grammatical type and sentence element of each word in the text string, at least one instruction for assigning priority values to the words in the text string according to their identified grammatical type and sentence element, and at least one instruction for transforming the text string by deleting a word from the text string having a highest assigned priority. These computer-readable medium may further include instructions for repeat the various instructions until all words in the text string have been selected or all words in the text string have been selected. The computer-readable medium may further include instructions for determining a priority value for each of the automated string transformation methods within the groups of automated string transformation methods, and for implementing automated string transformation methods in order of the determined priority value until the transformed text string fits within the maximum size for displayed strings.

In another aspect, a method for transforming a text string for display in a mobile device, includes determining a desired size range for displayed strings, determining a length of the text string, diagramming the text string to identify one or more locations within the text string where words can be inserted without changing a meaning of the text string, assigning priority values to the identified locations for inserting words in the text string, and inserting a word into at least one of the identified locations for inserting words in the text string. The inserted word may be selected from a list of words. The method further include inserting a word into each of the one or more locations within the text string where words can be inserted according to the assigned priority until the text string satisfies the desired size range for displayed strings.

In another aspect, a mobile device includes a display and a processor that is configured to perform operations including determining a desired size range for displayed strings, determining a length of the text string, diagramming the text string to identify one or more locations within the text string where words can be inserted without changing a meaning of the text string, assigning priority values to the identified locations for inserting words in the text string, and inserting a word into at least one of the identified locations for inserting words in the text string. The processor may be configured to select the inserted word from a list of words. The processor of the mobile device may further be configured to insert a word into each of the one or more locations within the text string where words can be inserted according to the assigned priority until the text string satisfies the desired size range for displayed strings.

In another aspect, a mobile device includes a means for determining a desired size range for displayed strings, a means for determining a length of the text string, a means for diagramming the text string to identify one or more locations within the text string where words can be inserted without changing a meaning of the text string, a means for assigning priority values to the identified locations for inserting words in the text string, and a means for inserting a word into at least one of the identified locations for inserting words in the text string. The mobile device may further include a means for selecting the inserted word from a list of words. The mobile device may further include a means for inserting a word into each of the one or more locations within the text string where words can be inserted according to the assigned priority until the text string satisfies the desired size range for displayed strings.

In another aspect, a computer program product includes a computer-readable medium including instructions for transforming a text string for display in a mobile device, including at least one instruction for determining a desired size range for displayed strings, at least one instruction for determining a length of the text string, at least one instruction for diagramming the text string to identify one or more locations within the text string where words can be inserted without changing a meaning of the text string, at least one instruction for assigning priority values to the identified locations for inserting words in the text string, and at least one instruction for inserting a word into at least one of the identified locations for inserting words in the text string. The computer-readable medium may further include at least one instruction for selecting the inserted word from a list of words. The computer-readable medium may further include at least one instruction for inserting a word into each of the one or more locations within the text string where words can be inserted according to the assigned priority until the text string satisfies the desired size range for displayed strings.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention. Wherever possible, the same reference numbers will be used throughout the drawings to refer to the same or like parts or processes.

FIG. 1 is a block diagram illustrating an overview of the various aspects.

FIG. 2 is a process flow diagram illustrating an overview process according to various aspects.

FIG. 3 is a process flow diagram of an example method suitable for implementation on a mobile handset.

FIG. 4 is a process flow diagram of an example method suitable for implementation on a mobile handset.

FIG. 5 is a process flow diagram of an example method suitable for implementation on a mobile handset.

FIG. 6A-6B are diagrams of example data structures suitable for use with various aspects.

FIG. 7 is a process flow diagram of an example method suitable for implementation on a mobile handset.

FIG. 8 is a diagram of a data structure suitable for use with various aspects.

FIG. 9 is a process flow diagram of an example method suitable for implementation on a mobile handset.

FIG. 10 is a diagram of a data structure suitable for use with various aspects.

FIG. 11 is a process flow diagram of an example method suitable for implementation on a mobile handset.

FIG. 12 is circuit block diagram of an example handset device suitable for use with the various aspects.

### DETAILED DESCRIPTION

The various aspects will be described in detail with reference to the accompanying drawings. References made to particular examples and implementations are for illustrative purposes, and are not intended to limit the scope of the invention or the claims.

As used herein, the terms “handset” and “handheld device” refer to any one or all of cellular telephones, personal data assistants (PDAs), palm-top computers, laptop computers, wireless electronic mail receivers (e.g., the Blackberry® and Treo® devices), multimedia Internet enabled cellular telephones (e.g., the iPhone®), and similar personal electronic devices which include a programmable processor and memory. In a preferred aspect, the mobile handset is a cellular handheld device that can communicate via a cellular telephone network (e.g., a cellphone). However, cellular telephone communication capability is not necessary in all aspects. Moreover, wireless data communication may be achieved by the handheld device connecting to a wireless data network (e.g., a WiFi network) instead of a cellular telephone network.

As used herein, the terms “string” and “text string” refer to either or both of a sequence of characters or symbols, and a data structure capable of storing a sequence of characters or symbols. The length of a string and the length of a string both refer to the number of characters or symbols in a string.

When a document primarily consisting of a series of text strings, such as an SMS message, a mobile handset may wrap the string to a new line and/or require a user to scroll to see the entire string. While commonly employed, scrolling to read messages may not be handy sometimes and many strings contain information that is superfluous to the intended communication.

The various aspects provide methods for reducing the length of a text string by identifying less essential elements of the string and deleting them. The essentiality of string element ultimately depends on the perspective of the reader and the writer. However, general rules can be developed that allow mobile handsets to identify string elements that can be deleted or modified to shorten the string without changing its meaning. For example, an aspect intended for use with the English language may recognize that certain words can be abbreviated and still convey the same meaning.

In the various aspects, handheld devices may be configured with software designed to analyze and modify text strings to shorten their length to fit a display size. Such software may be implemented as a stand alone application, as part of a text processing application (e.g., an SMS application), as part of the operating system implemented on the handheld device, or as an application programming interface (API). To simplify the description, this software is referred to herein as a “string transformation engine.” The string transformation engine may be part of a larger text rendering engine. Such a rendering engine may be responsible for a number of tasks known in the arts such as rasterisation, which includes converting characters into a pixel map, or more advanced techniques such as antialiasing and sub-pixel rendering. The text rendering engine may be part of a suite of applications that form a user interface, or part of an application that renders text, such as a web browser. Some text rendering may be performed by applications that are not easily classified as user interfaces or stand-alone applications, such as the BREW software found on some mobile phones. The scope of the invention and the claims are not limited by the text rendering application or software. While several examples described herein refer to SMS messages, the same methods and devices may be implemented in a similar manner to any text strings, including, for example, e-mail, text documents, HTML encoded documents, multimedia messaging service (MMS), etc.

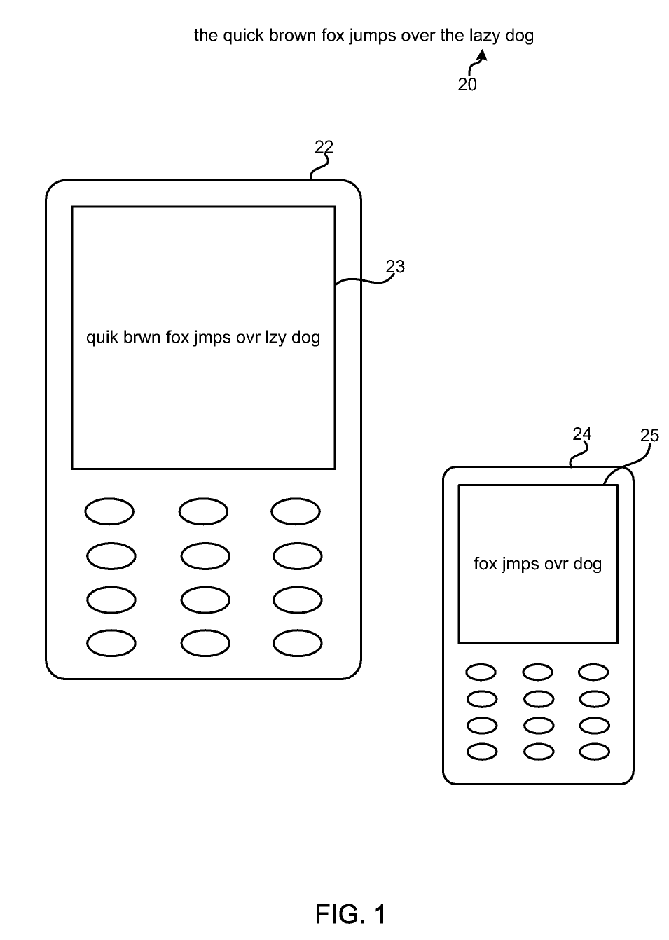

An example of how the various aspects may transform a string is shown in FIG. 1. In this example, a text string 20 ‘the quick brown fox jumped over the lazy dog’ is to be displayed on two mobile handsets 22 and 24. The two mobile handsets 22 and 24 have different size displays 23, 25, but neither is able to display the entire text string 20 without wrapping the string within the display. Each of the mobile handsets 22 and 24 may be equipped with a string transformation engine. To fit the text string 20 within the length of their respective displays 23, 25, the string transformation engines in each mobile handset may perform a series of transformation operations that incrementally reduce the length of the text string 20, stopping when the string has been sufficiently transformed to fit on the display 23, 25 of the mobile handset 22, 24. Since the first mobile handset 22 may have a larger display 23, the output of the string transformation engine in the first mobile handset 22 will output a different result than the string transformation engine in the smaller mobile handset 24 even though the two string transformation engines may implement the same transformation rules. For example, the larger mobile handset 22 may transform the text string 20 to ‘quik brwn fox jmps ovr lzy dog,’ while the smaller mobile handset 24 may transform the text string 20 to ‘fox jmps ovr dog.’ In both cases, a significant level of meaning has been maintained despite the transformation, but more meaning has been maintained with respect to the larger mobile handset 24. To most potential users, all of the meaning of the text string 20 has been maintained, despite deleting roughly one-third of the string (i.e., reducing string length from 44 characters to 30 characters).

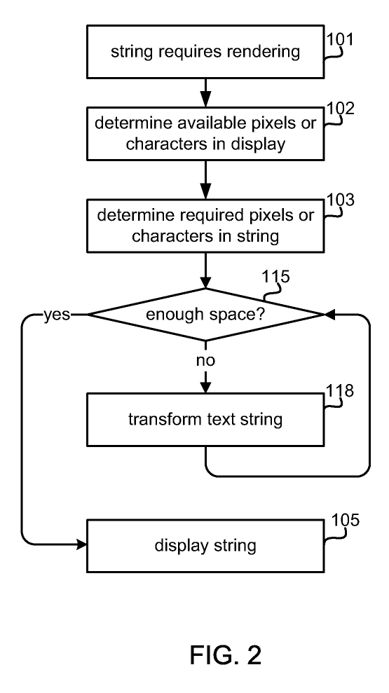

An overview of the various example methods that may be implemented to transform text strings is illustrated in FIG. 2. The string transformation engine may be activated when the text rendering engine needs to render a text string 20, block 101. The text string 20 may be passed to the string transformation engine as a parameter. Alternatively, the text string 20 may be static for a particular aspect, in which case the text string 20 may be programmed as a constant or variable that can be recalled from memory. The string transformation engine may determine the number of screen pixels or characters that will fit within the display, block 102. In some implementations the screen size in terms of pixel width or character width may be stored in memory as a constant (e.g., a device parameter) that the string transformation engine accesses at some point after activation (e.g., before or during processing of a text string). In other implementations, the pixel-width or character-width parameter may be programmed into the string transformation engine as a constant or algorithm element, in which case block 102 may not be performed explicitly. In yet another implementation the pixels or characters available in the display may be passed to the string transformation engine by the rendering engine, or it may be static for a particular aspect. The string transformation engine may determine the number of pixels or characters required to display the full text string 20 (i.e., the string without transformation), block 103. The string transformation engine may be configured to perform this determination or it may receive the string pixels/characters as parameter from the text rendering engine. Using this information the string transformation engine may determine whether the text string can be rendered in the space available, determination block 115. This determination may be accomplished by a simple comparison of the display's pixels/characters (i.e., an integer determined in block 102) to the required pixels/characters (i.e., an integer calculated or received in block 103). Alternatively, in some implementations, the text rendering engine may determine the available space, and the string transformation engine may determine if there is enough space, determination block 115, by querying the rendering engine whether there is enough space to display a given string.

If there is not enough space to display the text string without modification (i.e., determination block 115=“no”), the string transformation engine may transform the string to reduce the number of pixels characters, block 118. This may be accomplished incrementally in a series of transformations by repeating the process of determining whether the transformed text string will fit within the display, determination block 115, and further transforming the text string, block 118, as illustrated in FIG. 2. If the original or transformed text string will fit within display (i.e., determination block 115=“yes”), the transformed (or original) text string is returned to the text rendering engine for display, block 105.

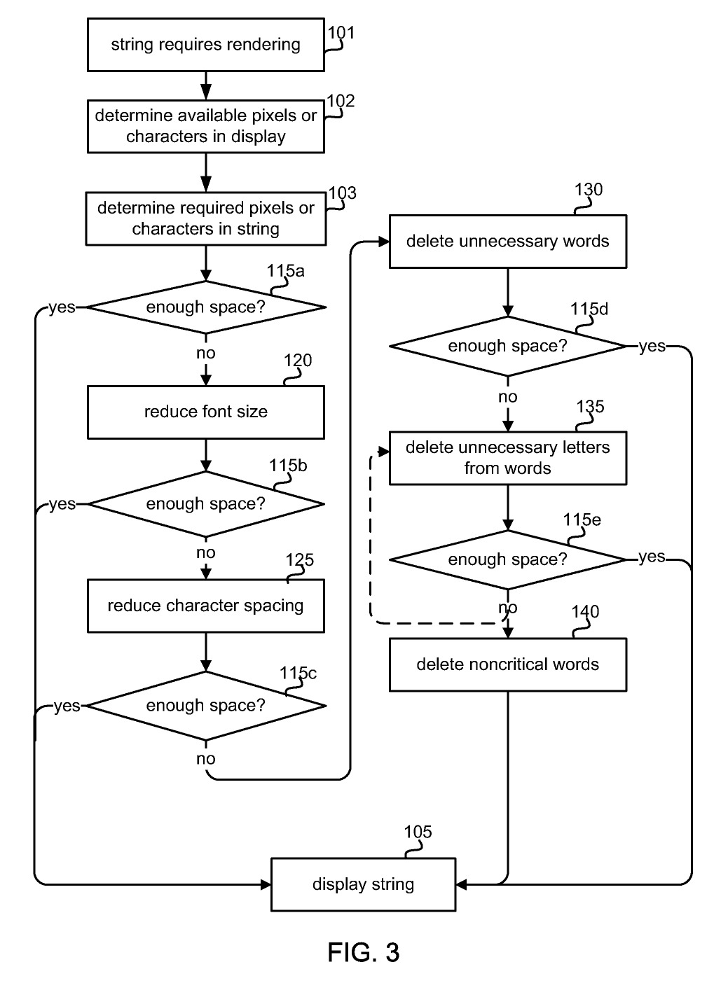

The string transformation (block 118) may be accomplished by sequentially applying a series of rule-based transformation as shown in FIG. 3. Similarly to the operations shown in FIG. 2, the string transformation engine may be activated by a text rendering engine to transform a text string, block 101. The string transformation engine may determine the number of pixels/characters available in the display, block 102, and the number of pixels/characters required to display the text string 20, block 103, and determine if there is enough space to display the string without transformation, decision block 115a as described above with reference to block 115 shown in FIG. 2. If there is enough display space for the text string (original or as transformed) (i.e., decision block 115a=“yes”), the text string is returned to the text rendering engine for display, block 105. If the text string will not fit within the display space (i.e., decision block 115a=“no”), the string transformation engine may perform a first operation of reducing the font size, block 120. The operation of reducing font size, block 120, is optional since in some mobile devices the font size will be static (i.e., unchangeable) while other models of mobile devices may enable a variety of font sizes to be implemented. The process of changing the font size, block 120, may include reducing the pixel size of the font, changing the font to a smaller font, or both. For example, in various implementations the font size may be reduced in block 120 by changing the font from fixed-width to variable-width, by changing the front from regular-width to narrow-width, or both. Transforming font size may be accomplished by applying a font transformation rule to the text string. After the font-transformation rule has been applied, the string transformation engine may repeat the process of determining whether there is enough room to display the transformed string, determination block 115b, by comparing the number of pixels or characters required to display the transformed string to the number of pixels or characters available in the display determined at block 102. If there is enough space to display the transformed string (i.e. determination block 115b=“yes”), then no more transformations are needed and the transformed text string is returned to the text rendering engine for display, block 105.

If the transformed string will not fit within the display (i.e., determination block 115b=no), the string transformation engine may reduce character spacing (i.e., the space between characters in the displayed string), block 125. Reducing character spacing may be accomplished by what is known in the typesetting arts as reducing kerning. The operation of reducing character spacing, block 125, is optional since in some mobile devices dynamic character spacing may not be possible or appropriate (e.g., if font transformation leaves too little space between characters). Reducing character spacing may be accomplished by applying a character spacing transformation rule to the text string. After the character spacing rule has been applied, the string transformation engine may again determine if there is enough room to display the transformed string, determination block 115c, by comparing the number of pixels or characters required to display the transformed string to the number of pixels or characters available in the display determined in block 102. If there is enough space to display the transformed string (i.e., determination block 115c=“yes”), then no more transformations are needed and the transformed text string is returned to the text rendering engine for display, block 105.

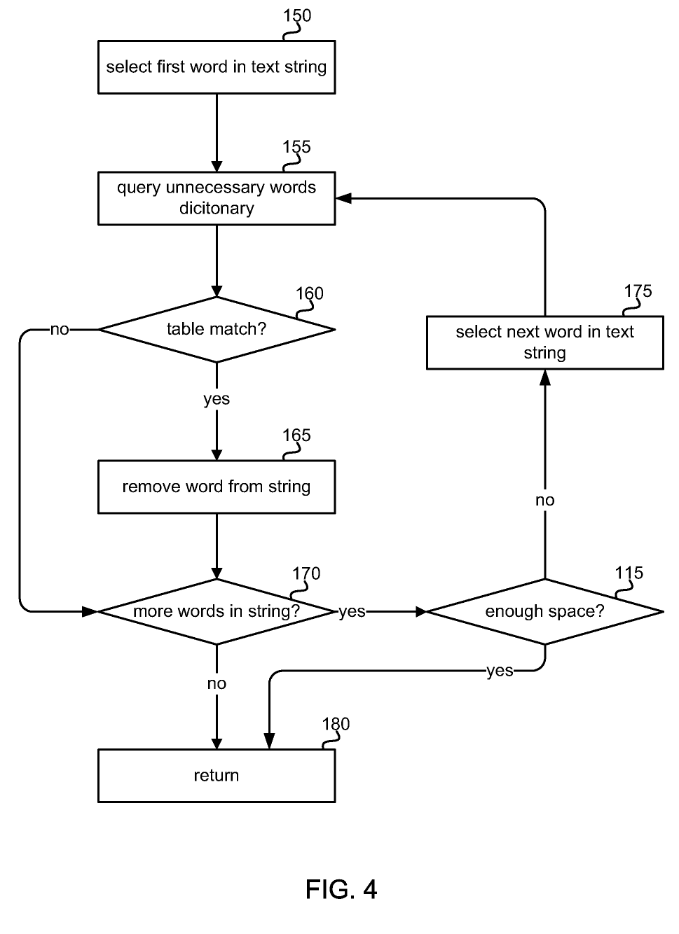

If the transformed string still will not fit within the display (i.e., determination block 115c=“no”), the string transformation engine may perform further transformations, such as deleting unnecessary words from the string, block 130. Unnecessary words are words that can be deleted without changing the meaning of the string. For example, articles such as ‘a’, ‘an’ and ‘the’ can be deleted from a sentence or phrase without affecting the readers ability to understand the remaining words. Applying a transformation rule that deletes articles to the example text string 20 ‘the quick brown fox jumps over the lazy dog’ results in the shortened text string ‘quick brown fox jumps over lazy dog’. Example processes and rules for deleting unnecessary words are discussed in more detail below with reference to FIG. 4. Once the unnecessary words have been deleted from the text string, the string transformation engine may again determine if there is enough room to display the transformed string, determination block 115d, by comparing the number of pixels or characters required to display the transformed string to the number of pixels or characters available in the display determined in block 102. If there is enough space to display the transformed string (i.e., determination block 115d=“yes”), then no more transformations are needed and the transformed text string is returned to the text rendering engine for display, block 105.

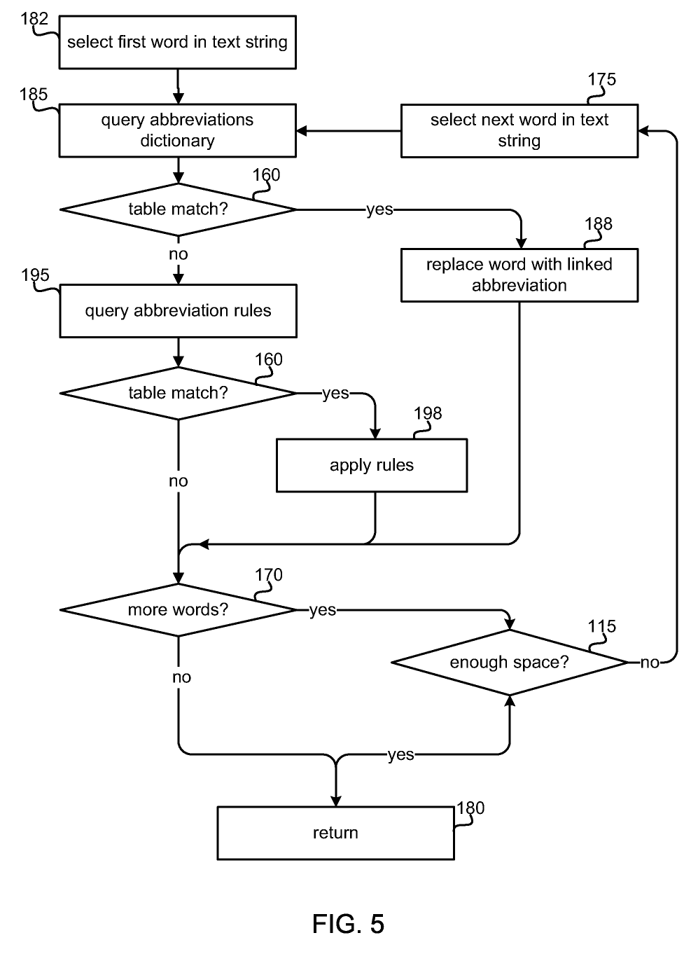

If the transformed string will not fit within the display (i.e., determination block 115d=“no”), the string transformation engine may perform further transformations, such as deleting unnecessary letters from the text string, block 135. Unnecessary letters are letters that can be deleted without changing the meaning of a word to a reader. This transformation operation may include replacing common words with standard abbreviations that most readers will recognize. For example, most users would recognize ‘avg’ as an abbreviation of average, and ‘bldg’ as an abbreviation for ‘building.’ This operation may also apply abbreviation rules to words so as to create abbreviations for words that are not commonly abbreviated. For example, most users would recognize ‘ovr’ as an abbreviation of ‘over’ within the context of the example text string 20. This operation may also delete or replace trailing letters in words, as words can often be recognized without such letters. For example, if the second-from-last letter of a word is a vowel and the word is four characters or more in length, that vowel may be deleted leaving a recognizable word. Applying this example transformation rule to the example text string 20 (which after the prior transformation reads ‘quick brown fox jumps over lazy dog’) would further transform the string to ‘quik brwn fox jmps ovr lzy dog.’ Despite shortening the string by 13 letters, the transformed string will be easily understood by many users as having the same meaning as the original text string 20. Example processes and rules for deleting unnecessary letters from words are discussed in more detail below with reference to FIG. 5. Once the unnecessary letters have been deleted, the string transformation engine may again determine if there is enough room to display the newly transformed string, determination block 115e, by comparing the number of pixels or characters required to display the transformed string to the number of pixels or characters available in the display determined in block 102. If there is enough space to display the transformed string (i.e., determination block 115e=yes), then no more transformations are needed and the transformed text string is returned to the text rendering engine for display, block 105.

Optionally, the operation of deleting unnecessary letters from words, block 135, may be performed incrementally, such as by abbreviating one or more words and determining whether the so transformed string will fit the display, determination block 115e, and then repeating the process, block 135, to delete further letters only if the transformed string will not fit the display (as illustrated by the dashed arrow). In this manner, words can be abbreviated or shortened only as necessary to fit a transformed string into the display.

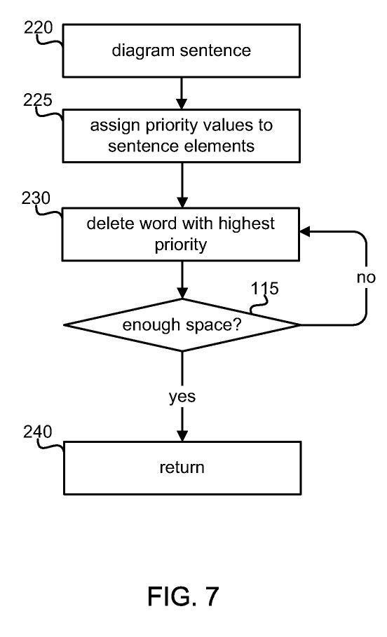

If the transformed string will not fit within the display after all unnecessary letters have been deleted (i.e., determination block 115e=“no”), the string transformation engine perform further transformations, such as deleting non-critical words from the base text string 20, block 140. A non-critical word is a word that is not necessary to convey the high-level semantics of the text string 20. Whether a word is critical to a text string may depend on many factors which may be implemented as a sequence of transformation rules. For example, a transformation rule may delete adjectives and adverbs on the presumption that only nouns and verbs are critical to the basic meaning of a sentence. Applying this simple transformation rule to example base text string 20 as transformed in the previous example results in the phrase ‘fox jmps ovr dog’. Non-critical word deletal transformation rules may take advantage of the well-defined semantics of the English language. For example, a noun can be the subject of a sentence or the object of the sentence. Many users would find both the subject and the object of the sentence to be critical. However, a noun can also be the object of a prepositional phrase, which may not be critical to understanding the meaning of some sentences. Example processes and rules for deleting non-critical words is discussed in more detail below with reference to FIG. 7. After deleting non-critical words, the transformed text string may be returned to the text rendering engine for display, block 105. If the transformation process was not able to create sufficient space, the rendering engine may take various measures such as truncating the string.

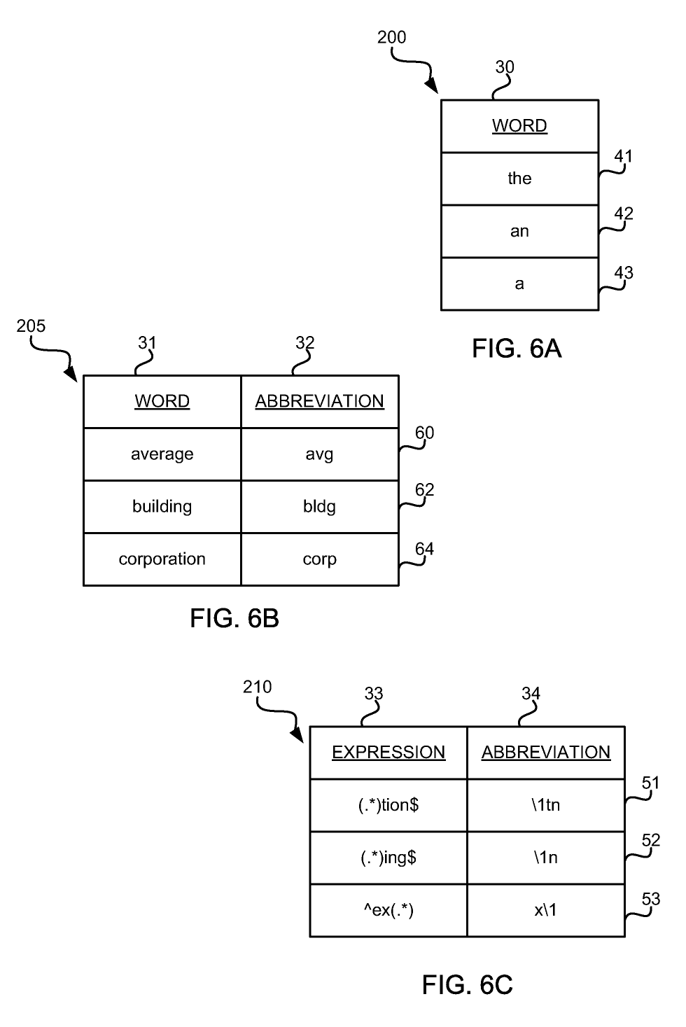

Operations or transformation rules that delete unnecessary words should delete only those words not critical to the meaning of a phrase. Since determining the meaning of a word within the context of a sentence is computational costly, this operation or transformation rule may be limited to words that generally do not carry significant meaning regardless of their position in a sentence. By limiting the transformation rule to deleting only such low-meaning words can obviate a need to analyze sentence structure. This type of transformation rule may be implemented using a look-up table or dictionary of unnecessary words, which may be merely a list of words stored in memory. For ease of reference, a look-up table or list of words used for such purposes is referred to herein as a “dictionary.” A data structure that can serve as a dictionary for such purposes is discussed below with reference to FIG. 6A.

It should be appreciated that the order of transformation operations illustrated in FIG. 3 is arbitrary and that transformation rules may be applied in any order. Additionally, different transformation rules may be implemented without departing from the spirit of the invention and the claims. Also, while FIG. 3 illustrates the determination blocks 115a-115e as being implemented sequentially, one of skill in the art will appreciate that the operations may be implemented in a variety of equivalent manners, including loops, comparison circuits, decision trees, etc.

Additionally, the operations illustrated in FIG. 3 may be implemented in a single step in which the amount of space required to be deleted from a text string is determined (e.g., by subtracting the pixels/characters available in the display determined in block 102 from the number of pixels/characters in the original string determined in block 103), and based upon that result, determining which of the various transformation rules to apply. For example, if the excess number of pixels/characters in the text string is small, the font size and unnecessary word deletion transformation rules may be applied; however, if the number is large, all of the transformation rules may be applied.

Operations for deleting unnecessary words based on a dictionary are illustrated in FIG. 4. For ease of description and illustration, the operations are shown and described as implemented in a subroutine of operations such as a function call within the string transformation engine (e.g., in block 130 of FIG. 3). However, the operations may alternatively be implemented within the string transformation engine as a conditional loop or similar programming structure. When the string transformation engine implements an operation to delete unnecessary words (e.g., block 130 of FIG. 3), the operation may begin by selecting the first word of the sentence for analysis, block 150. The operation may query an unnecessary words dictionary to see if the dictionary contains the first word, block 155. The specifics of how this query operates will depend in part on the data structure of the dictionary and, accordingly, is discussed below with reference to FIG. 6A. The operation may determine if the selected word is unnecessary based upon whether the word matches or substantially matches an entry in the unnecessary word dictionary, determination block 160. Any of the variety of methods for comparing a word, a portion of a word (e.g., the last few letters) or a sequence of letters and numbers to a list or data table are well known in the computer programming arts may be utilized in this operation (which is also referred to herein as a table look-up process). As one of skill in the art will appreciate, known word look-up methods can accommodate the fact that a word used in a look-up can match an entry in a list or data table even though the look-up word is not be identical to the list or table entry word. For example, a noun look-up word may be plural, and thus include an ‘s’ or ‘es’ and so be slightly different from the singular version of the word included in the list or data table. As another example, a verb look-up word may be conjugated and thus include different endings, such as ‘ming’ or ‘ed’ or be spelled differently, such as ‘ran’ which is the past tense of ‘run’. A variety of approaches can be used in list/table look-up processes to account for such differences and identify a satisfied entry even when the look-up word only substantially matches the entry word. For example, wild card characters (e.g., ‘*’) may be included in list/data table entry to account for differences in conjugation or plurality. Also, as described in more detail below, in some aspects the list/table look-up operations may focus only on the conjugation endings (e.g., ‘ming’ and ‘ed’). To reflect this flexibility in matching a portion or all of a look-up word to list or data table entries, a satisfied look-up operation is referred to herein as a condition in which a selected word “substantially matches” an entry in a list, data table or dictionary.

If the selected word substantially matches an entry in the unnecessary word dictionary (i.e., determination block 160=“yes”), then the word may be deleted from the text string, block 165. The operation may then determine if there is another word in the text string to analyze, determination block 170. If the selected word does not substantially match an entry in the unnecessary word dictionary, indicating that the word is not unnecessary (i.e., determination block 160=“no”), the operation does not delete the word and determines if there is another word in the string, determination block 170. If there are no more words in the text string (i.e., determination block 170=“no”), the entire string has been analyzed so the operation may return to the higher level process, block 180, such as by returning to the text transformation engine processing if the operation is implemented as a subroutine or function call.

If there is another word in the string (i.e., determination block 170=“yes”), the operation may determine if further transformation processing is required by determining if the transformed string can fit within the display, determination block 115 as described above with reference to FIG. 2. If there is enough space to display the transformed string (i.e., determination block 115=“yes”), the operation may return to the higher level process, block 180, such as returning to the text transformation engine processing. If the transformed string will not fit within the display (i.e., determination block 115=“no”), the operation may select the next word in the string for analysis, block 175, and continue with the processing described above by using the selected word to query the unnecessary words dictionary, returning to block 155. The processing may proceed in this manner until either all words in the string have been analyzed (i.e., determination block 170=“no”) or the transformed string will fit within the display (i.e., determination block 115=“yes”).

The determination of whether a transformed string will fit within the display (i.e., determination block 115) is optional and may not be implemented because stripping out some but not all unnecessary words might result in transformations that are distracting to some users. In such an implementation, the operation may proceed directly to select the next word for analysis, block 175, if there are more words in the string (i.e., determination block 170=yes).

As previously discussed, an operation of deleting unnecessary letters from words may involve identifying letters in a word that are not critical for a user to recognize the word or involve replacing words with common abbreviations. Such transformation rules may utilize one or more data structures that store common abbreviations and other abbreviation rules. Examples of such data structures are discussed below with reference to FIGS. 6B and 6C. An example method that deletes unnecessary letters from words utilizing two such data structures is illustrated in FIG. 5. Similar to the operation illustrated in FIG. 4, the operations of abbreviating words and/or deleting unnecessary letters from words are described and illustrated as a subroutine or function that may be called within the string transformation engine, but also could be implemented within the string transformation engine as a conditional loop or similar approach.

Referring to FIG. 5, when the string transformation engine implements an operation to delete unnecessary letters (e.g., block 135 of FIG. 3), this operation may select the first word of the text string for analysis, block 182. Since this operation may be implemented after other operations have been used to transform the text string, this operation may select the first word that substantially matches an entry in the transformed string. The operation may use the selected word to query an abbreviations dictionary in a table look-up process, block 185. The look-up process determines if the selected word substantially matches an entry in the abbreviations dictionary, determination block 160, which indicates that there is a common abbreviation for the word. The specifics of the query process depend on the specifics of the data structure, and accordingly are discussed more fully below with reference to FIG. 6B. If the selected word substantially matches an entry in the abbreviation dictionary (i.e., determination block 160=“yes”), the operation may replace the word with the abbreviation linked or corresponding to the substantially matched word in the dictionary, block 188, and determine if there is another word in the string to be analyzed, determination block 170.

If the selected word does not substantially match an entry in the abbreviation dictionary, indicating that there is no common abbreviation for the selected word stored in the dictionary (i.e., determination block 160=“no”), the operation may determine if there are any abbreviation rules that can be apply to the first word by querying an abbreviation rules list, block 195, and analyzing the results of the query, determination block 160. As previously discussed, abbreviation rules may include pattern-based rules that can be used to identify letters that can be deleted. For example, since most users will recognize ‘swimmn’ as meaning ‘swimming,’ one abbreviation rule may be that for words ending in ‘ming’, replace ‘ming’ ‘n’. Further details regarding implementing abbreviation rules are discussed below with reference to FIG. 6C. If there is an abbreviation rule that applies to the first word (i.e., determination block 160=“yes”), then the operation may apply the corresponding abbreviation, block 198. The operation then may determine if there is another word in the string, determination block 170. If there is another word in the string to be analyzed (i.e., determination block 170=“yes”), the operation may determine if further transformation processing is required by determining if the transformed string can be displayed within the display space, determination block 115, by comparing the number of pixels or characters required to display the transformed string to the number of pixels or characters available in the display. If the transformed string fits within the display space (i.e., determination block 115=“yes”), the string transformation engine may return to the higher level process, block 180, such as by returning to the text transformation engine processing if the operation is implemented as a subroutine or function call. If the transformed string will not fit within the display space (i.e., determination block 115=“no”), the operation may select the next word in the string, block 175, and continue with processing that deletes unnecessary letters from words as described above by using the selected word to query the abbreviations dictionary, returning to block 185. The processing may proceed in this manner until either all words in the string have been analyzed (i.e., determination block 170=“no”) or the transformed string fits within the display (i.e., determination block 115=“yes”).

The determination of whether a transformed string fits within the display (i.e., determination block 115) is optional and may not be implemented because abbreviating some but not all words might result in transformations that are distracting to some users. In such an implementation, the operation may proceed directly to selecting the next word, block 175, if there are more words in the string to be analyzed (i.e., determination block 170=“yes”).

As previously discussed, the various operations may utilize data structures to transform text strings, examples of which are illustrated in FIG. 6A-6C. The data structures may be implemented using any of the various data structures known in the arts, such as arrays, linked lists, b-tree data tables, and decision trees.

As discussed above with reference to FIG. 4, unnecessary words within a text string may be identified for deletion using an unnecessary words dictionary. An example of an unnecessary words dictionary 200 is shown in FIG. 6A in the form of a data table. In this example data structure unnecessary words listed in a plurality of data records each including a lone data field 30. For example, rows (i.e., data records) 41, 42, and 43 contain the unnecessary words ‘the’, ‘a’ and ‘an’. A string transformation engine that utilizes an unnecessary words dictionary 200 can determine if a given word in a text string 20 is unnecessary simply by determining if the word is contained in the unnecessary words dictionary 200. In other words, if a selected word is found in the unnecessary words dictionary 200, the word is presumed to be unnecessary in the text string and can be deleted.

As discussed above with reference to FIG. 5, an abbreviation dictionary 205 can be used to determine if there is a common abbreviation for a selected word. An example data structure for an abbreviation dictionary 205 is illustrated in FIG. 6B. This example data structure includes a plurality of data records each including a first data field 31 which stores a word that has an abbreviation, and a second data field 32 which stores the abbreviation for the word stored in the first data field 31. For example, row (i.e., data record) 60 may include the word ‘average’ in the first data field 31 and its abbreviation ‘avg’ in the second data filed 32. A string transformation engine that utilizes an abbreviation dictionary 205 may determine if a selected word in a text string 20 can be abbreviated by determining if that word is in data field 31 of any data record, and if so, replacing the word with the abbreviation stored in the second data field 32 of the same row or record.

As discussed above with reference to FIG. 5, an abbreviation rules list 210 can be used to determine how to shorten or abbreviate words that do not have a common abbreviation. An example data structure for an abbreviation rules list 210 is illustrated in FIG. 6C. This example data structure includes a plurality of data records each including a first data field 33 which includes an expression that a processor can use to identify words which will substantially match each abbreviation rule. A second data field 34 in each data record includes a rule that can be applied by the processor to the selected word. For example, the first data field 33 may include regular expressions which are known in the programming arts as a well-defined formal language for substantially matching text patterns. For example, the regular expression ‘(.*)ing$’ shown in row 52 will substantially match any word ending in ‘ming,’ since the expression ‘(.*)’ may allows for any sequence of characters to be matched, and ‘$’ indicates the end of the word. More complex regular expressions may enable the identification of more complex patterns, such as words having a length four or more letters with a vowel in the first and second-from-last positions. The second data field 34 include replacement or transformation rules which indicate how a matched string should be transformed. For example, row 52 includes the expression ‘\ln’ which indicates that a word substantially matching the first data field criteria (i.e., ending in ‘ing’) can be transformed by replacing the ‘ing’ with ‘n’. In this rule notation the ‘\n’ portion of the rule refers to the sequence substantially matching the ‘(.*)’ portion of the regular expression. Therefore, when this rule is applied to ‘swimming’ the word will be transformed to become ‘swimmn’ and ‘playing’ with transformed to ‘playn’. A string transformation engine or operation may apply the abbreviation rules by using a selected word as a look up value to determine if the word substantially matches a word in data field 33 and, if a substantial match is found, applying the rule in data field 34 of the substantially matched data record. In cases multiple transformation rules may not be performed at once. In such cases, the abbreviation resulting from the abbreviation rule may be run through the abbreviation rules list 210 a second (or further) time to determine whether further another abbreviation rule will apply to the transformed word. In some implementations, the data table may be configured so there is only one abbreviation per word.

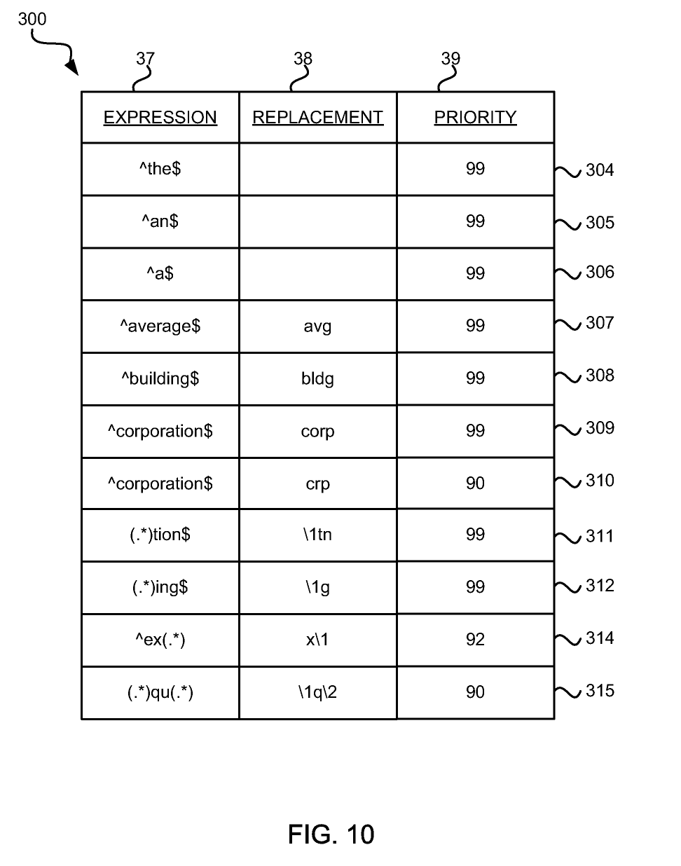

While FIGS. 6A-6C are illustrated as separate data tables, one of skill in the art will appreciate that the tables can be combined into one or two tables, or other known data structure, without departing from the spirit of the invention or the claims. An example of such a combined data structure is described below with reference to FIG. 10.

As discussed above with reference to FIG. 3, the string transformation engine may delete non-critical words that are not necessary to convey the high-level semantics of the text string. This operation may involve analyzing the entire string as a phrase or sentence rather than word by word, similar to how a grammar checker application operates (in contrast to a spellchecker application). An example method for identifying non-critical words for deletion is illustrated in FIG. 7. This operation is described and illustrated as implemented in a subroutine of operations such as a function call within the string transformation engine (e.g., in block 140 of FIG. 3). However, the operations may alternatively be implemented within the string transformation engine as a conditional loop or similar programming structure. When the string transformation engine implements an operation to delete non-critical words the operation may begin by diagramming the phrase or sentence, block 220. Sentence diagramming is a method for creating a parse tree, which is well known in the arts as a method for identifying the syntactical parts of a text string. Any known algorithm or process for diagramming sentences may be implemented in this and similar operations described herein. With respect to strings in the English language, a simple sentence diagramming process may split a sentence string into a subject phrase, a verb phrase, and an object phrase. A more complex sentence diagramming process may identify a noun as the object of a prepositional phrase. In some implementations, the sentence diagramming logic may require the original string to be intact, and in such an implementations, the string transformation engine may perform the sentence diagramming process on the text string prior to other shortening operations, such as deleting unnecessary words or abbreviating words. Once the operation has diagrammed the sentence and created a parse tree, the operation may determine which words or elements are most or least critical and assign a priority value to each element, block 225. For example, a noun in a subject phrase may be very critical to the semantics of a string, and thus would have a low priority for deletion, whereas an adjective in the subject phrase would be less critical to semantics, thus would have a higher priority for deletion. The operation may then delete the word in text string with the highest priority for deletion, block 230, and determine if the thus transformed string fits within the display space, determination block 115. If the transformed string fits within the display space (i.e., determination block 115=“yes”), the operation can return to the higher level procedure, block 240, such as by returning to the text transformation engine processing if the operation is implemented as a subroutine or function call. If the transformed string will still not fit within the display space (i.e., determination block 115=“no”), operation may delete the word in the text string with the next highest priority, repeating block 230, and check whether the transformed string fits within the display space, repeating block 115. Since the operation of deleting non-critical words may be applied after abbreviation rules have been applied, the operation of deleting a word from the string will be applied to delete any modified version of that word, such as an abbreviated or shortened version of the word.

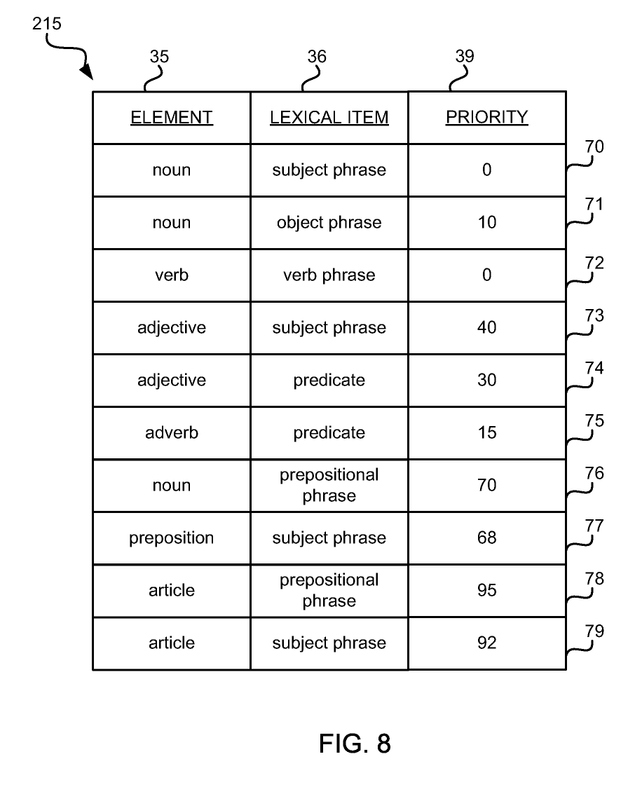

The rules for assigning words a priority for deletion based on the parse tree may be implemented in a table look-up method using a data table such as shown in FIG. 8. In this example, a sentence element criticality priority table 215 may be structured as a plurality of data records (rows) 70-79 each including a series of data fields 35, 36, 39. For example, each data record may include a first data field 35 that contains a type of sentence element, such as noun, verb, adjective, etc. For example, a word may be a noun, which is a type of sentence element. The second data field 36 may contain a lexical item, which may be a reference to a syntactical structure of an English-language phrase. For example, in row 71 the second data field 36 includes ‘object phrase’ which is a lexical item in an English-language sentence. In some implementations, the possible values stored in data field 36 may not be mutually exclusive. For example, the object phrase is part of the predicate of a sentence. The set of possible values for data field 36 may correspond to the functionality of the sentence diagramming logic implemented in the string transformation engine. The sentence element criticality priority table 215 may also include a data field 39 in which is stored a priority value which may be assigned to a word substantially matching the criteria specified in the first two data fields. For example, if a particular word within a text string is determined by sentence diagramming operation to substantially match the criteria (data fields 35 and 36) of row 70 of the criticality priority table 215 because it is a noun within the subject phrase of the string, it may be assigned a priority value of zero as shown in data field 39. This makes sense because the noun in the subject phrase is critical to the meaning of most sentences. In another example, if a particular word within a text string is determined by sentence diagramming operation to substantially match the criteria (data fields 35 and 36) of row 73 of the criticality priority table 215 because the particular word is an adjective within the subject phrase of the string, the particular word may be assigned a priority value of 40 as shown in data field 39. This makes sense because an adjective in the subject phrase is of much less importance to the meaning of most sentences, and thus can be deleted without losing much of the meaning of the sentence string. In the case where the possible values of data field 36 are not mutually exclusive, the operation may assign the lowest possible value to a particular word.

The criticality priority table 215 also illustrates how the operation of deleting unnecessary words can be combined with the operation of deleting non-critical words. For example, data records 78 and 79 indicate that articles (e.g., ‘a’, ‘an’, ‘the’, etc.) are assigned high priority for deletion as compared to other parts of a sentence. Thus, the operation described above with reference to FIG. 7 in conjunction with a data table such as illustrated in FIG. 8 can delete articles as a first step toward shortening strings in a manner than can replace or supplement the operation process described above with reference to FIG. 4.

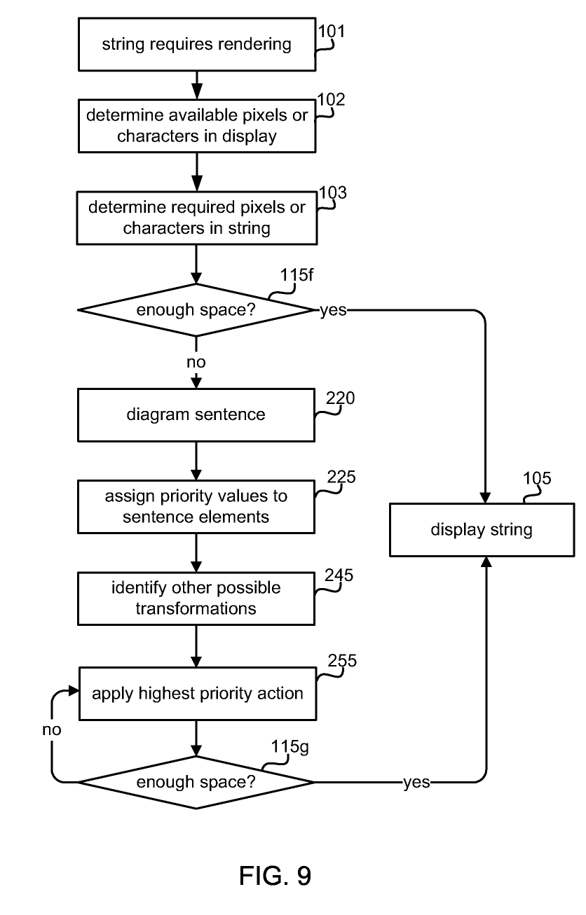

In another example implementation of a string transformation engine, the basic operations of reducing font size, reducing character spacing, deleting unnecessary words, deleting unnecessary letters from words, and deleting non-critical words described above with reference to FIGS. 2-8 may be applied in different order depending upon the string to be displayed. For example, operations may be implemented to apply abbreviation rules after some uncritical words are deleted. This implementation may involve analyzing the text string to determine appropriate transformation operations or rules that may be applied to the text string, assigning a priority value to each appropriate transformation operation or rule, and applying the transformation operations or rules in order of priority. An example method for accomplishing this implementation is illustrated in FIG. 9. Similarly to FIGS. 2 and 3, the string transformation engine may begin when the rendering engine indentifies a text string for display, block 101. The string transformation engine may determine how many pixels or characters are available within the display, such as by querying the rendering engine, accessing a parameter table or through embedded logic, block 102. The string transformation engine may also determine the number of pixels or characters needed to display the input text string, block 103. The string transformation engine may determine if the text string will fit within the display space in its current form as described above with reference to FIG. 2, determination block 115f. If the string will fit within the display (i.e., determination block 115f=“yes”) the string transformation engine may not process the string and return the string to the rendering engine for display, block 105. However, if the string will not fit within the display (i.e., determination block 115f=“no”), the string transformation engine may prepare to transform the text string by diagramming the sentence of text string, block 220, and assigning criticality priority values to the words in the strings based on the results, block 225. In doing so, the string transformation engine may utilize a critical priority table 215 similar to that illustrated in FIG. 8 to determine the priority values appropriate for each word in the text string. The string transformation engine may also identify any other transformations that may be made, block 245, such as identifying words that can be abbreviated or words that are unnecessary, and assign a priority to each identified alternative transformation, block 250. Similar to the methods described above with reference to FIGS. 4-6, the operations of identifying potential transformations for the words within the string can be accomplished by comparing the words to one or more data tables to identify appropriate transformations. Similarly, the look-up data tables may include a priority value for each transformation. With all possible transformations identified and given a priority value, the string transformation engine may apply the transformations in order of priority until the text string 20 is of sufficient size, blocks 255, 115g. This may be accomplished by applying the highest priority action (i.e., the action with the highest priority value) first, block 255, and determining if the transformed string fits within the display space, determination block 115g. If the transformed string fits within the display space (i.e., determination block 115f=“yes”), then the string has been sufficiently transformed, and the string transformation engine may return the string to the rendering engine for display, block 105. If the transformed string will not fit within the display space (i.e., determination block 115g=“no”), the string transformation engine may repeat the operation of applying the transformation action with the next highest priority, repeating block 255, and determining if the transformed string fits within the display space, repeating determination block 115g. In this manner, the transformation operations and rules will be applied in priority order until the transformed string can be displayed within the display space (i.e., determination block 115g=“yes”).

The method described above with reference to FIG. 9 may be implementing in conjunction with a transformation priority table 300 such as the data structure such as that shown in FIG. 10. A transformation priority table 300 may include a plurality of data records (rows) 304-315, each including a series of data fields 37-39. For example, the transformation priority table 300 may include a first data field 37 storing a regular expression for matching words or word patterns within a string. As discussed previously, regular expressions allow the use of wild cards to match text to patterns. However, a regular expression need not use a wild card. For example, the expression ‘̂average$’ is a valid regular expression that will match only the exact word ‘average’. Each of the data records in the transformation priority table 300 may also contain a data field 38 storing a replacement rule. As previously discussed, the replacement rule may refer to the regular expression, such as ‘\ln’. However, a replacement rule may be static, such as the rule ‘avg’ to replace a word that matches the regular expression ‘̂average$’ with its abbreviation. The transformation priority table 300 may also contain a data field 39 storing a transformation priority value. In some cases, a word within a string may match several regular expressions. For example, the abbreviation ‘bldg’ might be the preferred abbreviation for ‘building’ (see row 308), but the abbreviation ‘bdg’ might also be acceptable, as well as the shorten version ‘buildn’ (see row 312). The transformation priority table 300 may contain a replacement rule for each abbreviation with different priority values, such as 99 and 90, respectively. The string transformation engine may first replace ‘building’ with ‘buildn,’ the replace ‘building’ with ‘bldg,’ and later replace it with ‘bdg’ if the text string 20 is not sufficiently transformed prior to reaching actions with priority 90.

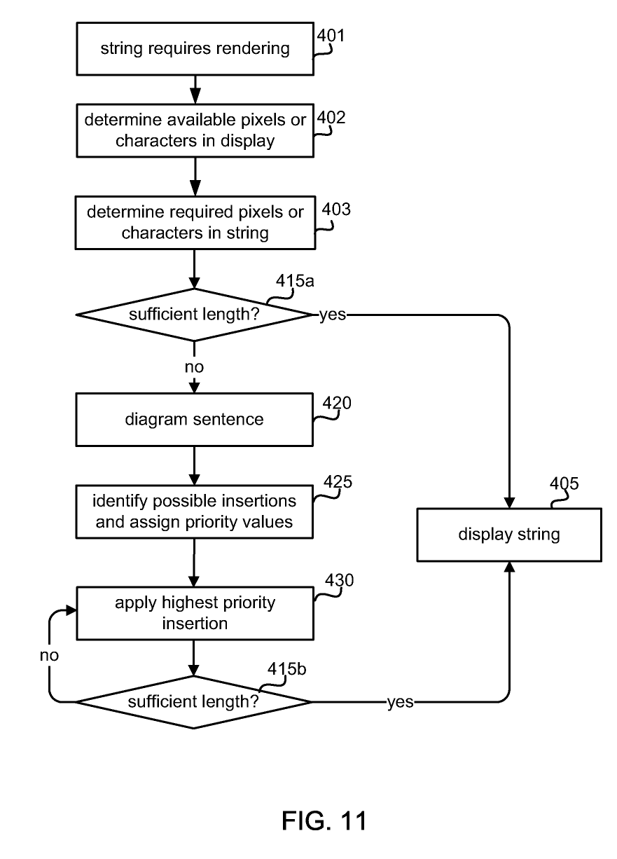

The basic methods may be modified and implement in order to expand strings, such as to expand the length of the string. This may be beneficial to the user experience by making text more readable, or more entertaining. An example method for expanding a string is illustrated in FIG. 11, which shows process operations that may be implemented on a mobile handset. The method may commence when there is a text string is to be displayed, block 401. The mobile handset may determine the minimum number of pixels or characters that the text string should take up on the display, block 402. The mobile handset may also determine how many pixels or characters are required to display the text string in its current state, block 403. The mobile handset may determine whether the current length of the string is sufficient by comparing the minimum pixel or character length (i.e., the result of block 402) with the number of pixels or characters required by the string (i.e., the results of block 403), determination block 415a. Other display criteria may also be applied, such as a range of lengths, a minimum font size, etc.

If the length of the string is sufficient to meet the display criteria or length (i.e., determination block 415a=“yes”), the mobile handset may display the string, block 405. If the string length is not sufficient (i.e., determination block 415a=“no”), the mobile handset may begin the expansion process by diagramming the sentence represented by the text string in a manner similar to that discussed above with reference to FIGS. 7 and 9, block 420. With the sentenced diagramed, the mobile handset may identify locations within the string in which additional words may be inserted without changing the meaning, and assign a priority value to each insertion location, block 425. For example, applying the method to the sample text string 20 from FIG. 1 (i.e., ‘the quick brown fox jumps over the lazy dog’) may identify that filler adjectives can be added in conjunction with other adjectives in the string, namely ‘quick’ and ‘brown.’ Additionally, the method may identify the start and end of the string as locations where inconsequential expressions can be added without affecting the meaning. A data table or list of filler words may then be used to select insertion words and phrases to be insert. For example, additional adjectives like ‘super,’ ‘real,’ can be inserted before ‘quick’ to expand the length of the string without substantially changing its meaning. As an example, the data table or list of filler words may conform to a theme, such as “California surfer” which may include words like ‘gnarly,’ ‘tubular,’ ‘dude,’ etc. Where multiple insertions are identified as possible, the mobile handset may be configured to preferentially insert an adjective modifying the subject of the sentence before inserting an adjective modifying the object of the sentence. In such a case, the insertion point before the subject would have a higher priority. Once the possible insertions have been identified and assigned a priority, the mobile handset may execute the highest priority insertion, block 430, and then determine if the length of the transformed text string is sufficient to fill the desired display space, determination block 415b. If the transformed string length is sufficient, the mobile handset may display the string, block 405. If not (i.e., determination block 415b=“no”), the mobile handset may continue to expand the string by inserting a word at the point with the highest remaining priority value, repeating block 430, and again determining if the current text string 20 has sufficient length, repeating determination block 415b. The process may then continue in this manner, adding words and phrases according to the theme word list until the transformed text string has the desired length (i.e., decision block 415b=“yes”).

The processing methods described above for transforming text strings, either to reduce or expand their length, may be accomplished any time prior to display, including in parallel to the creation of the string (e.g., while a user is typing the string). In the case of strings communicated from/to mobile devices, the string transformation methods may be applied to text strings before they are transmitted to a mobile device, as well as to strings received by a mobile device.

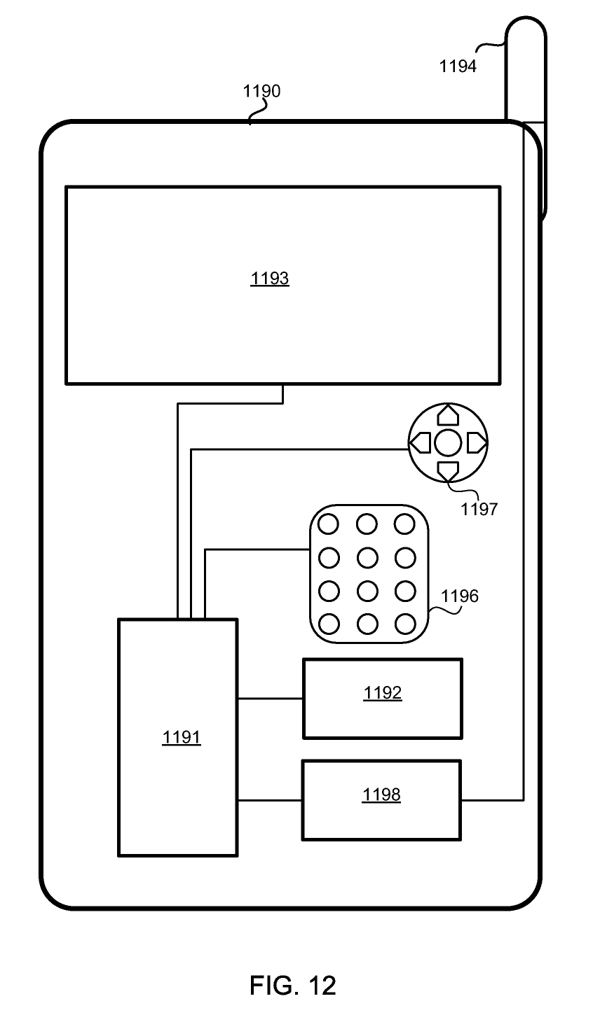

The methods described above may be implemented on any of a variety of mobile handsets. Typically, such mobile handsets will have in common the components illustrated in FIG. 12. For example, the mobile handset 1190 may include a processor 1191 coupled to internal memory 1192 and a display 1193. Additionally, the mobile handset 1190 may have an antenna 1194 for sending and receiving signals that is connected to a wireless data link and/or cellular telephone transceiver 1198 coupled to the processor 1191. The processor 1191 may be any programmable microprocessor, microcomputer or multiple processor chip or chips that can be configured by software instructions to perform a variety of functions, including the functions of the various methods described above. Typically, software applications may be stored in the internal memory 1192 before they are accessed and loaded into the processor 1191. In some mobile handsets, the processor 1191 may include internal memory sufficient to store the application software instructions. For the purposes of this description, the term memory refers to all memory accessible by the processor 1191, including internal memory 1192 and memory within the processor 1191 itself. Data files, such as the data structures illustrated in FIGS. 6A-6C, 8 and 10, will typically be stored in the memory 1192. In many mobile handsets, the memory 1192 may be a volatile or nonvolatile memory, such as flash memory, or a mixture of both. Mobile handsets typically include a key pad 1196 or miniature keyboard and menu selection buttons or rocker switches 1197 for receiving user inputs.

The hardware used to implement the foregoing methods may be processing elements and memory elements configured to execute a set of instructions, wherein the set of instructions are for performing method operations corresponding to the above methods. Alternatively, some operations or methods may be performed by circuitry that is specific to a given function.

Those of skill in the art will appreciate that the various illustrative logical blocks, modules, circuits, and algorithm operations described in connection with the methods disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The operations of a method or algorithm described in connection with the aspects disclosed herein may be embodied directly in hardware, in a software module executed by a processor, or in a combination of the two. The software module may reside in a processor readable storage medium and/or processor readable memory both of which may be any of RAM memory, flash memory, ROM memory, EPROM memory, EEPROM memory, registers, hard disk, a removable disk, a CD-ROM, or any other tangible form of data storage medium known in the art. Moreover, the processor readable memory may comprise more than one memory chip, memory internal to the processor chip, in separate memory chips, and combinations of different types of memory such as flash memory and RAM memory. References herein to the memory of a mobile handset are intended to encompass any one or all memory modules within the mobile handset without limitation to a particular configuration, type or packaging. An exemplary storage medium is coupled to a processor in either the mobile handset or the theme server such that the processor can read information from, and write information to, the storage medium. In the alternative, the storage medium may be integral to the processor. The processor and the storage medium may reside in an ASIC. The ASIC may reside in a user terminal or mobile device. In the alternative, the processor and the storage medium may reside as discrete components in a user terminal or mobile device. Additionally, in some aspects, the operations and/or actions of a method or algorithm may reside as one or any combination or set of codes and/or instructions on a machine readable medium and/or computer readable medium, which may be incorporated into a computer program product.

The foregoing description of the various aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein, and instead the claims should be accorded the widest scope consistent with the principles and novel features disclosed herein.

What is claimed is:

1. A method for transforming a text string for display in a mobile device, comprising:
determining a maximum size for displayed text strings;
determining a length of the text string; and
transforming the text string so that the transformed text string fits within the maximum size for displayed text strings, wherein transforming the text string is accomplished using an automated string transformation method selected from the group consisting of: deleting unnecessary words from the text string; replacing some words in the text string with abbreviations; deleting one or more letters from selected words in the text string; and identifying and deleting non-critical words from the text string.

2. The method of claim 1, wherein transforming the text string further comprises an automated string transformation method selected from the group consisting of changing a font size and font spacing.

3. The method of claim 1, wherein the automated string transformation method is deleting unnecessary words from the text string, said method of deleting unnecessary words from the text string, comprising:
selecting a word from the text string;
comparing the selected word to a list of unnecessary words; and
transforming the text string by deleting the selected word if the selected word substantially matches an entry in the list of unnecessary words.

4. The method of claim 3, wherein said method of deleting unnecessary words from the text string further comprises repeating the operations of selecting a word from the text string, comparing the selected word to a list of unnecessary words, and transforming the text string by deleting the selected word if the selected word substantially matches an entry in the list of unnecessary words, until all words in the text string have been selected.

5. The method of claim 3, wherein said method of deleting unnecessary words from the text string further comprises:
determining whether the transformed text string fits within the maximum size for displayed text strings; and
repeating the operations of selecting a word from the text string, comparing the selected word to a list of unnecessary words, and transforming the text string by deleting the selected word if the selected word substantially matches an entry in the list of unnecessary words, until either the transformed text string fits within the maximum size for displayed text strings or all words in the text string have been selected.

6. The method of claim 1, wherein the automated string transformation method is replacing some words in the text string with abbreviations, said method of replacing some words in the text string with abbreviations, comprising:
selecting a word from the text string;
comparing the selected word to an abbreviation dictionary; and
transforming the text string by replacing the selected word with an abbreviation of the selected word identified in the dictionary if the selected word substantially matches an entry in the abbreviation dictionary.

7. The method of claim 6, wherein said method of replacing some words in the text string with abbreviations further comprises repeating the operations of selecting a word from the text string, comparing the selected word to an abbreviation dictionary; and transforming the text string by replacing the selected word with an abbreviation of the selected word identified in the dictionary if the selected word substantially matches an entry in the abbreviation dictionary, until all words in the text string have been selected.

8. The method of claim 1, wherein the automated string transformation method is deleting one or more letters from selected words in the text string, said method of deleting one or more letters from selected words in the text string, comprising:
selecting a word from the text string;
comparing the selected word to a list of word transformation rules; and
transforming the text string by transforming the selected word if the selected word substantially matches a criteria in the list of word transformation rules.

9. The method of claim 8, wherein said method of deleting one or more letters from selected words in the text string further comprises:
repeating the operations of selecting a word from the text string, comparing the selected word to a list of word transformation rules, and transforming the text string by transforming the selected word if the selected word substantially matches a criteria in the list of word transformation rules, until all words in the text string have been selected.

10. The method of claim 1, wherein the automated string transformation method is identifying and deleting non-critical words from the text string, said method of identifying and deleting non-critical words from the text string, comprising:
diagramming the text string to identify a grammatical type and sentence element of each word in the text string;
assigning priority values to the words in the text string according to their identified grammatical type and sentence element; and
transforming the text string by deleting a word from the text string having a highest assigned priority.

11. The method of claim 10, wherein said method of identifying and deleting non-critical words from the text string further comprises:
determining whether the transformed text string fits within the maximum size for displayed strings; and
repeating the operation of transforming the text string by deleting a word from the text string having a highest assigned priority until the transformed text string fits within the maximum size for displayed strings.

12. The method of claim 2, further comprising:
determining a priority value for each of the automated string transformation methods within the groups of automated string transformation methods; and
implementing automated string transformation methods in order of the determined priority value until the transformed text string fits within the maximum size for displayed strings.

13. A mobile device, comprising:
a processor;
a display coupled to the processor; and
a memory coupled to the processor,
wherein the processor is configured to perform operations comprising:
determining a maximum size for displayed text strings;
determining a length of a text string; and
transforming the text string so that the transformed text string fits within the maximum size for displayed text strings, wherein transforming the text string is accomplished by the processor accomplishing an automated string transformation process selected from the group consisting of: deleting unnecessary words from the text string; replacing some words in the text string with abbreviations; deleting one or more letters from selected words in the text string; and identifying and deleting non-critical words from the text string.

14. The mobile device of claim 13, wherein the processor is configured with software instructions such that in transforming the text string the processor further accomplishes an automated string transformation process selected from the group consisting of changing a font size and font spacing.

15. The mobile device of claim 13, wherein the processor is configured with software instructions such that the automated string transformation method accomplished by the processor deletes unnecessary words from the text string by performing operations comprising:
selecting a word from the text string;
comparing the selected word to a list of unnecessary words; and
transforming the text string by deleting the selected word if the selected word substantially matches an entry in the list of unnecessary words.

16. The mobile device of claim 15, wherein the processor is configured to repeat the operations of selecting a word from the text string, comparing the selected word to a list of unnecessary words, and transforming the text string by deleting the selected word if the selected word substantially matches an entry in the list of unnecessary words, until all words in the text string have been selected.

17. The mobile device of claim 15, wherein the processor is configured to perform operations further comprising:
determining whether the transformed text string fits within the maximum size for displayed strings; and
repeating the operations of selecting a word from the text string, comparing the selected word to a list of unnecessary words, and transforming the text string by deleting the selected word if the selected word substantially matches an entry in the list of unnecessary words, until either the transformed text string fits within the maximum size for displayed text strings or all words in the text string have been selected.

18. The mobile device of claim 13, wherein the processor is configured with software instructions such that the automated string transformation method accomplished by the processor replaces some words in the text string with abbreviations by performing operations comprising:
selecting a word from the text string;
comparing the selected word to an abbreviation dictionary; and
transforming the text string by replacing the selected word with an abbreviation of the selected word identified in the dictionary if the selected word substantially matches an entry in the abbreviation dictionary.

19. The mobile device of claim 18, wherein the processor is configured with software instructions to repeat the operations of selecting a word from the text string, comparing the selected word to an abbreviation dictionary; and transforming the text string by replacing the selected word with an abbreviation of the selected word identified in the dictionary if the selected word substantially matches an entry in the abbreviation dictionary, until all words in the text string have been selected.

20. The mobile device of claim 13, wherein the processor is configured with software instructions such that the automated string transformation method accomplished by the processor deleting one or more letters from selected words in the text string by performing operations comprising:
selecting a word from the text string;
comparing the selected word to a list of word transformation rules; and
transforming the text string by transforming the selected word if the selected word substantially matches a criteria in the list of word transformation rules.

21. The mobile device of claim 20, wherein the processor is configured with software instructions to repeat the operations of selecting a word from the text string, comparing the selected word to a list of word transformation rules, and transforming the text string by transforming the selected word if the selected word substantially matches a criteria in the list of word transformation rules, until all words in the text string have been selected.

22. The mobile device of claim 13, wherein the processor is configured with software instructions such that the automated string transformation method accomplished by the processor identifies and deletes non-critical words from the text string by performing operations comprising:
diagramming the text string to identify a grammatical type and sentence element of each word in the text string;
assigning priority values to the words in the text string according to their identified grammatical type and sentence element; and
transforming the text string by deleting a word from the text string having a highest assigned priority.

23. The mobile device of claim 22, wherein the processor is configured with software instructions to perform further operations comprising:
determining whether the transformed text string fits within the maximum size for displayed text strings; and
repeating the operation of transforming the text string by deleting a word from the text string having a highest assigned priority until the transformed text string fits within the maximum size for displayed strings.

24. The mobile device of claim 14, wherein the processor is configured with software instructions to perform further operations comprising:
determining a priority value for each of the automated string transformation methods within the groups of automated string transformation methods; and
implementing automated string transformation methods in order of the determined priority value until the transformed text string fits within the maximum size for displayed text strings.

25. A mobile device, comprising:
means for determining a maximum size for displayed text strings;
means for determining a length of the text strings; and
means for transforming the text string so that the transformed text string fits within the maximum size for displayed text strings, wherein means for transforming the text string is accomplished using an automated string transformation means for selected from the group consisting of: means for deleting unnecessary words from the text string; means for replacing some words in the text string with abbreviations; means for deleting one or more letters from selected words in the text string; and means for identifying and deleting non-critical words from the text string.

26. The mobile device of claim 25, wherein means for transforming the text string further comprises automated string transformation means selected from the group consisting of means for changing a font size and means for font spacing.

27. The mobile device of claim 25, wherein the automated string transformation means is means for deleting unnecessary words from the text string, comprising:
means for selecting a word from the text string;
means for comparing the selected word to a list of unnecessary words; and
means for transforming the text string by deleting the selected word if the selected word substantially matches an entry in the list of unnecessary words.

28. The mobile device of claim 27, wherein means for deleting unnecessary words from the text string further comprises means for repeating the operations of selecting a word from the text string, comparing the selected word to a list of unnecessary words, and transforming the text string by deleting the selected word if the selected word substantially matches an entry in the list of unnecessary words, until all words in the text string have been selected.

29. The mobile device of claim 27, wherein means for deleting unnecessary words from the text string further comprises:
means for determine whether the transformed text string fits within the maximum size for displayed strings; and
means for repeating the operations of selecting a word from the text string, comparing the selected word to a list of unnecessary words, and transforming the text string by deleting the selected word if the selected word substantially matches an entry in the list of unnecessary words, until either the transformed text string fits within the maximum size for displayed strings or all words in the text string have been selected.

30. The mobile device of claim 25, wherein the automated string transformation means is means for replacing some words in the text string with abbreviations, comprising:
means for selecting a word from the text string;
means for comparing the selected word to an abbreviation dictionary; and
means for transforming the text string by replacing the selected word with an abbreviation of the selected word identified in the dictionary if the selected word substantially matches an entry in the abbreviation dictionary.

31. The mobile device of claim 30, wherein means for replacing some words in the text string with abbreviations further comprises means for repeating the operations of selecting a word from the text string, means for comparing the selected word to an abbreviation dictionary; and means for transforming the text string by replacing the selected word with an abbreviation of the selected word identified in the dictionary if the selected word substantially matches an entry in the abbreviation dictionary, until all words in the text string have been selected.

32. The mobile device of claim 25, wherein the automated string transformation means is means for deleting one or more letters from selected words in the text string, comprising:
means for selecting a word from the text string;
means for comparing the selected word to a list of word transformation rules; and
means for transforming the text string by transforming the selected word if the selected word substantially matches a criteria in the list of word transformation rules.

33. The mobile device of claim 32, wherein means for deleting one or more letters from selected words in the text string further comprises means for repeating the operations of selecting a word from the text string, comparing the selected word to a list of word transformation rules, and transforming the text string by transforming the selected word if the selected word substantially matches a criteria in the list of word transformation rules, until all words in the text string have been selected.

34. The mobile device of claim 25, wherein the automated string transformation means is means for identifying and deleting non-critical words from the text string, comprising:
means for diagramming the text string to identify a grammatical type and sentence element of each word in the text string;
means for assigning priority values to the words in the text string according to their identified grammatical type and sentence element; and
means for transforming the text string by deleting a word from the text string having a highest assigned priority.

35. The mobile device of claim 34, wherein means for identifying and deleting non-critical words from the text string further comprises:
means for determine whether the transformed text string fits within the maximum size for displayed text strings; and
means for repeating the operation of transforming the text string by deleting a word from the text string having a highest assigned priority until the transformed text string fits within the maximum size for displayed text strings.

36. The mobile device of claim 26, further comprising:
means for determining a priority value for each of the automated string transformation means within the groups of automated string transformation means; and
means for implementing the automated string transformation means in order of the determined priority value until the transformed text string fits within the maximum size for displayed strings.

37. A computer program product, comprising:
a computer-readable medium, comprising:
at least one instruction for determining a maximum size for displayed text strings;
at least one instruction for determining a length of a text string; and
at least one instruction for transforming the text string so that the transformed text string fits within the maximum size for displayed text strings, wherein the at least one instruction for transforming the text string is selected from the group consisting of: at least one instruction for deleting unnecessary words from the text string; at least one instruction for replacing some words in the text string with abbreviations; at least one instruction for deleting one or more letters from selected words in the text string; at least one instruction for and identifying and deleting non-critical words from the text string.

38. The computer product of claim 37, wherein the computer-readable medium further includes at least one instruction for an automated string transformation process selected from the group consisting of at least one instruction for changing a font size and at least one instruction for changing a font spacing.

39. The computer product of claim 37, wherein the at least one instruction for transforming the text string includes at least one instruction for deleting unnecessary words from the text string by performing operations comprising:
at least one instruction for selecting a word from the text string;
at least one instruction for comparing the selected word to a list of unnecessary words; and
at least one instruction for transforming the text string by deleting the selected word if the selected word substantially matches an entry in the list of unnecessary words.

40. The computer product of claim 39, wherein the computer-readable medium further comprises at least one instruction for repeating the operations of selecting a word from the text string, comparing the selected word to a list of unnecessary words, and transforming the text string by deleting the selected word if the selected word substantially matches an entry in the list of unnecessary words, until all words in the text string have been selected.

41. The computer product of claim 39, wherein the computer-readable medium further comprises:
at least one instruction for determining whether the transformed text string fits within the maximum size for displayed text strings; and
at least one instruction for repeating the operations of selecting a word from the text string, comparing the selected word to a list of unnecessary words, and transforming the text string by deleting the selected word if the selected word substantially matches an entry in the list of unnecessary words, until either the transformed text string fits within the maximum size for displayed text strings or all words in the text string have been selected.

42. The computer product of claim 37, wherein the at least one instruction for transforming the text string includes at least one instruction for replacing some words in the text string with abbreviations by performing operations comprising:
at least one instruction for selecting a word from the text string;
at least one instruction for comparing the selected word to an abbreviation dictionary; and
at least one instruction for transforming the text string by replacing the selected word with an abbreviation of the selected word identified in the dictionary if the selected word substantially matches an entry in the abbreviation dictionary.

43. The computer product of claim 42, wherein the computer-readable medium further comprises at least one instruction for repeating the operations of selecting a word from the text string, comparing the selected word to an abbreviation dictionary; and transforming the text string by replacing the selected word with an abbreviation of the selected word identified in the dictionary if the selected word substantially matches an entry in the abbreviation dictionary, until all words in the text string have been selected.

44. The computer product of claim 37, wherein the at least one instruction for transforming the text string includes at least one instruction for deleting one or more letters from selected words in the text string by performing operations comprising:
at least one instruction for selecting a word from the text string;
at least one instruction for comparing the selected word to a list of word transformation rules; and
at least one instruction for transforming the text string by transforming the selected word if the selected word substantially matches a criteria in the list of word transformation rules.

45. The computer product of claim 44, wherein the computer-readable medium further comprises at least one instruction repeating the operations of selecting a word from the text string, comparing the selected word to a list of word transformation rules, and transforming the text string by transforming the selected word if the selected word substantially matches a criteria in the list of word transformation rules, until all words in the text string have been selected.

46. The computer product of claim 37, wherein the at least one instruction for transforming the text string includes at least one instruction for identifying and deleting non-critical words from the text string by performing operations comprising:
at least one instruction for diagramming the text string to identify a grammatical type and sentence element of each word in the text string;
at least one instruction for assigning priority values to the words in the text string according to their identified grammatical type and sentence element; and
at least one instruction for transforming the text string by deleting a word from the text string having a highest assigned priority.

47. The computer product of claim 46, wherein the computer-readable medium further comprises:
at least one instruction for determining whether the transformed text string fits within the maximum size for displayed text strings; and
at least one instruction for repeating the operation of transforming the text string by deleting a word from the text string having a highest assigned priority until the transformed text string fits within the maximum size for displayed text strings.

48. The computer product of claim 38, wherein the computer-readable medium further comprises:
at least one instruction for determining a priority value for each of the automated string transformation methods within the groups of automated string transformation methods; and
at least one instruction for implementing automated string transformation methods in order of the determined priority value until the transformed text string fits within the maximum size for displayed strings.

49. A method for transforming a text string for display in a mobile device, comprising:
determining a desired size range for displayed text strings;
determining a length of the text string;
diagramming the text string to identify one or more locations within the text string where words can be inserted without changing a meaning of the text string;
assigning priority values to the identified locations for inserting words in the text string; and
inserting a word into at least one of the identified locations for inserting words in the text string.

50. The method of claim 49, wherein the inserted word is selected from a list of words.

51. The method of claim 49, further comprising inserting a word into each of the one or more locations within the text string where words can be inserted according to the assigned priority until the text string satisfies the desired size range for displayed text strings.

52. A mobile device, comprising:
a processor;
a display coupled to the processor; and
a memory coupled to the processor,
wherein the processor is configured to perform operations comprising:
determining a desired size range for displayed text strings;
determining a length of the text string;
diagramming the text string to identify one or more locations within the text string where words can be inserted without changing a meaning of the text string;
assigning priority values to the identified locations for inserting words in the text string; and
inserting a word into at least one of the identified locations for inserting words in the text string.

53. The mobile device of claim 52, wherein the processor is configured with software instructions such that the inserted word is selected from a list of words stored in the memory.

54. The mobile device of claim 52, wherein the processor is configured with software instructions to perform further operations comprising inserting a word into each of the one or more locations within the text string where words can be inserted according to the assigned priority until the text string satisfies the desired size range for displayed strings.

55. A mobile device, comprising:
means for determining a desired size range for displayed text strings;
means for determining a length of the text string;
means for diagramming the text string to identify one or more locations within the text string where words can be inserted without changing a meaning of the text string;
means for assigning priority values to the identified locations for inserting words in the text string; and
means for inserting a word into at least one of the identified locations for inserting words in the text string.

56. The mobile device of claim 55, wherein means for inserting a word into at least one of the identified locations for inserting words in the text string comprises means for selecting the inserted word from a list of words.

57. The mobile device of claim 55, further comprising means for inserting a word into each of the one or more locations within the text string where words can be inserted according to the assigned priority until the text string satisfies the desired size range for displayed strings.

58. A computer program product, comprising:
a computer-readable medium, comprising:
at least one instruction for determining a desired size range for displayed text strings;
at least one instruction for determining a length of the text string;
at least one instruction for diagramming the text string to identify one or more locations within the text string where words can be inserted without changing a meaning of the text string;
at least one instruction for assigning priority values to the identified locations for inserting words in the text string; and
at least one instruction for inserting a word into at least one of the identified locations for inserting words in the text string.

59. The computer program product of claim 58, wherein the at least one instruction for inserting a word into at least one of the identified locations for inserting words in the text string comprises at least one instruction for selecting the inserted word from a list of words.

60. The computer program product of claim 58, wherein the computer-readable medium further comprises at least one instruction for inserting a word into each of the one or more locations within the text string where words can be inserted according to the assigned priority until the text string satisfies the desired size range for displayed text strings.
